(19) United States
(12) Patent Application Publication
(10) Pub. No.: US 2026/0267024 A1
(43) Pub. Date: Sep. 10, 2026

(54) SYSTEM AND METHOD FOR ULTRA-HIGH RESOLUTION SEISMIC DATA ACQUISITION

(71) Applicant: Oceaneering International, Inc., Houston, TX (US)

(72) Inventors: Emerson VERISSIMO, Houston, TX (US); Darrell BURCH, West Columbia, TX (US); Nikolaus GRIBB, Houston, TX (US)

(73) Assignee: Oceaneering International, Inc., Houston, TX (US)

(21) Appl. No.: 19/558,880

(22) Filed: Mar. 6, 2026

Related U.S. Application Data
(60) Provisional application No. 63/768,726, filed on Mar. 7, 2025.

(51) Int. Cl. G01V 1/38; G01V 1/137; G01V 1/24

(52) U.S. Cl. CPC G01V 1/3843; G01V 1/137; G01V 1/24; G01V 1/3808

(57) ABSTRACT

The disclosed invention discloses a system and methodology for marine seismic data acquisition which may concurrently obtain low-resolution or standard resolution seismic data for deep hydrocarbon exploration below a seabed along with ultra-high resolution seismic data for imaging near-surface sub-surface hazards. The dataset acquired using the disclosed system and methodology comprises deep-penetration, low-frequency seismic traces for long offsets, combined with shallow-penetration, high-frequency seismic traces for near offsets. These traces are distributed over a predetermined two-dimensional area or three-dimensional volume of the Earth’s subsurface.

### CROSS-REFERENCE TO RELATED APPLICATIONS

This application claims priority through United States Provisional Application 63/768,726 filed on Mar. 7, 2025, incorporated herein by reference.

### BACKGROUND OF THE INVENTION

The disclosed invention describes a system and method that implements a novel approach to including ultra-high resolution seismic data acquisition techniques from shallow hazard surveys with traditional towed multi-streamer two- and three-dimensional seismic acquisition.

### BRIEF DESCRIPTION OF DRAWINGS

Various figures are included herein which illustrate aspects of embodiments of the disclosed inventions.

FIG. 1 is a schematic view of an exemplary three-dimensional implementation of marine seismic data acquisition designed to concurrently obtain low-resolution or standard resolution seismic data for deep hydrocarbon exploration below the seabed, along with ultra-high resolution seismic data for imaging near-surface sub-surface hazards;

FIG. 2 is a schematic view of an exemplary two-dimensional implementation of marine seismic data acquisition designed to concurrently obtain low-resolution or standard resolution seismic data for deep hydrocarbon exploration below the seabed, along with ultra-high resolution seismic data for imaging near-surface sub-surface hazards; and

FIG. 3 is a schematic view of an exemplary array of acoustic source equipment.

### DETAILED DESCRIPTION OF EMBODIMENTS OF THE INVENTION

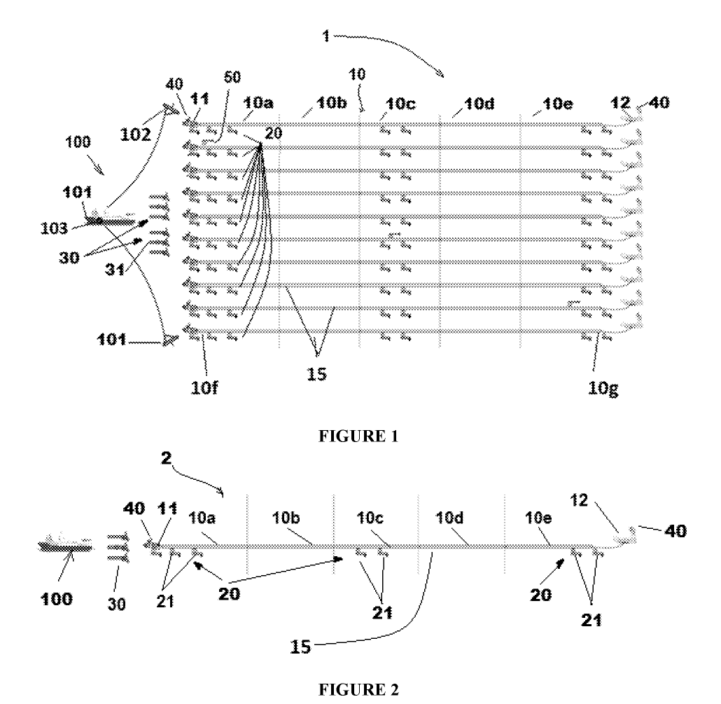

In a first embodiment, referring generally to FIG. 1, system for marine seismic data acquisition 1 comprises a source 30, at least one gun string 30 comprising one or more acoustic signal sources 31, and a predetermined number of streamers 15. Although two sets of three gun strings 30 are illustrated, the actual number of gun strings 30 is not so limited and can comprise one or more such gun strings 30.

As illustrated in FIG. 1, the predetermined number of streamers 15 may comprise a plurality of active streamers 10, each comprising a length sufficient to be distributed over a three-dimensional volume of the Earth’s subsurface. Although ten streamers 15 are illustrated, the actual number of streamers 15 is not so limited and can comprise a plurality of streamers 15. In other embodiments, referring now to FIG. 2, the predetermined number of streamers 15 may comprise a single active streamer 10 comprising a length sufficient to be distributed over a predetermined two-dimensional area using system for marine seismic data acquisition 2. Typically, each streamer 15 comprises one active streamer 10 comprising first end 10f, second end 10g, and a predetermined set of stream sections 10a-10e disposed in-between first end 10f and second end 10g.

Headfloat 11 is typically operatively connected to first end 10f of active streamer 10. One or more relative global positioning system sensor pods (RGPS) 40 are typically operatively connected to headfloat 11.

Tailbuoy 12 is typically operatively connected to second end 10g of active streamer 10. Tailbuoy 12 typically also comprises one or more RGPS pods 40.

A plurality of acoustic pod groups 20 is typically operatively connected to specific stream sections 10a-10e of the predetermined set of stream sections 10a-10e, each acoustic pod group 20 comprising a predetermined set of acoustic pod receivers 21 which are operative to sense an acoustic signal from acoustic source 31. A predetermined set of acoustic pod groups 20 may comprise cable mounted acoustic pod receivers 21. Although illustrated as three sets of acoustic pod groups 20, the actual number may vary depending on situational needs and each acoustic pod group 20 may comprise one or more acoustic pod receivers 21. Although two acoustic pod receivers 21 are illustrated, the actual number of acoustic pod receivers 21 is not so limited. Each acoustic pod group 20 is displaced from each adjacent acoustic pod group 20 by a predetermined separation distance, e.g., a predetermined separation distance of around 12.5 meters.

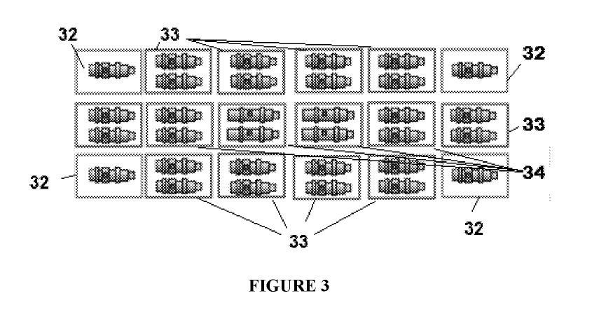

In embodiments, referring to FIG. 3, acoustic signal source 31 comprises one or more small volume air guns 32, one or more medium volume air guns 33, and one or more large volume air guns 34. As used herein, a “gun” comprises sources such as a single or multi-level sparker, boomer, pinger, chirp marine vibrator, or the like, or a combination thereof Small, medium, and large volume are terms understood by those of ordinary skill in subsea acoustic arts. Small volume air guns 32 may comprise a small volume pneumatic or sparker acoustic signal source 32, medium volume air guns 33 may comprise a medium volume pneumatic or sparker acoustic signal source 32, and large volume air guns 34 may comprise a large volume pneumatic or sparker acoustic signal source 34.

An exemplary arrangement of acoustic signal source 31 is illustrated in FIG. 3. Typically, acoustic signal source 31 comprises an array of acoustic signal sources 31 arranged in a predetermined pattern comprising a predetermined set of small volume air guns 32; a predetermined set of medium volume air guns 33; and a predetermined set of large volume air guns 34. As illustrated in FIG. 3, the source 30 may comprise three gun strings 30 and a middle gun string 30 of the three gun strings 30 may comprise a center of acoustic signal source 31. In most embodiments, acoustic signal source 31 comprises a gun string acoustic pinger which may comprise a deep-penetration, low-frequency acoustic generator suitable for seismic traces with long offsets and a shallow-penetration, high-frequency acoustic generator suitable for seismic traces with seismic traces for near offsets. In currently contemplated embodiments, acoustic signal source 31 and acoustic pod receivers 21 comprise a first predetermined set of closely spaced near-offset seismic receivers and a second predetermined set of more sparsely separated long-offset receivers disposed along a single active streamer 10 of the predetermined number of streamers.

Velocimeter 50 is typically operatively connected to at least one active streamer 10 proximate first end 10f of that active streamer 10.

One or more signal receivers 100 are also typically present. Signal receiver 100 may comprise vessel 101 and a predetermined set of antennae 102 operatively connected to vessel 101 and operatively in communication with acoustic pod groups 20.

In the operation of exemplary methods, referring back to FIG. 1, the disclosed invention typically pertains to a methodology for marine seismic data acquisition designed to concurrently obtain low-resolution or standard resolution seismic data for deep hydrocarbon exploration below the seabed, along with ultra-high resolution seismic data for imaging near-surface sub-surface hazards.

The dataset acquired using the disclosed methodology comprises deep-penetration, low-frequency seismic traces for long offsets, combined with shallow-penetration, high-frequency seismic traces for near offsets. These traces are distributed over a predetermined two-dimensional area or three-dimensional volume of the Earth’s subsurface.

The recording and acoustic source equipment are configured such that near-offset seismic receivers are closely spaced, while long-offset receivers are more sparsely separated along a single streamer cable, e.g., acoustic streamer 10. A small volume pneumatic or sparker source may be fired at tight intervals, i.e., within range of 1 to 25 meter shot point intervals, for shallow penetration, ultra-high resolution data acquisition, concurrently with a large volume pneumatic or sparker source fired at sparser intervals that is greater than the ultra-high resolution shot point interval, typically from 6.25 meters to 100 meters, for exploratory hydrocarbon surveys. The recording sample rate in the time domain is optimized by selecting recording system 103 capable of high sample rates to provide a wave-field that is appropriately sampled by the receivers, ensuring that the subsurface reconstruction meets both ultra-high and low-resolution or standard resolution imaging requirements. Providing a wave-field that is appropriately sampled by the signal receiver 100 may help ensure that subsurface reconstruction meets both ultra-high and low-resolution or standard resolution imaging requirements.

The combined dataset recording may be executed in a single pass of vessel 101, significantly enhancing survey efficiency. Combining the data into a combined dataset recording may be executed in a single signal receiver pass such as by using a software system that has the ability to view or display seismic data in a single acquisition system using the disclosed methodology.

Typically, system for marine seismic acquisition 1, as discussed above, is deployed subsea from the back deck of vessel 100 by dragging or towing source 30 and the predetermined number of streamers 15 behind vessel 101; a first acoustic signal is fired other otherwise provided from first acoustic signal source 31, which is as described above, at a first predetermined set of timed intervals for shallow penetration; and one or more of signal receivers 100 are used to acquire a first set of data from one or more acoustic pod groups 20, e.g., via antennae 102, where the first set of data may define ultra-high resolution data as that term is understood by those of ordinary skill in subsea seismic arts. Data may be acquired from subsurface geology where these data may define ultra-high resolution data that contains acoustic frequencies greater than 250 Hz. Concurrently, a second acoustic signal from a second acoustic signal source 31, which may comprise large volume pneumatic or sparker acoustic signal source 34, may be fired or otherwise supplied at a second predetermined set of time intervals for exploratory hydrocarbon surveys. Signal receiver 100 is used to acquire a second set of ultra-high resolution data from a sub-surface using one or more acoustic pod groups 20 and the data recorded at a predetermined recording sampling rate by recording system 103 at a predetermined recording sampling rate. The two sets of data may be combined into a combined dataset recording. The resulting data may be combined using software into a combined dataset recording such as via recording system 103.

The foregoing disclosure and description of the inventions are illustrative and explanatory. Various changes in the size, shape, and materials, as well as in the details of the illustrative construction and/or an illustrative method may be made without departing from the spirit of the invention.

1. A system for marine seismic data acquisition, comprising:
a) a source, at least one gun string comprising an acoustic signal source;
b) a predetermined number of streamers, each streamer comprising:
i) an active streamer comprising:
(1) a first end;
(2) a second end; and
(3) a predetermined set of stream sections disposed in-between the first end and the second end, the predetermined set of stream sections defining a predetermined active streamer length;
ii) a headfloat operatively connected to the first end of the active streamer;
iii) a first relative global positioning system sensor (RGPS) pod operatively connected to the headfloat;
iv) a tailbuoy operatively connected to the second end of the active streamer, the tailbuoy comprising a second RGPS pod;
v) a plurality of acoustic pod groups, each acoustic pod group displaced from each adjacent acoustic pod group by a predetermined separation distance along the length of the active streamer, each acoustic pod group comprising a predetermined set of acoustic pod receivers operative to sense an acoustic signal from the acoustic source;
c) a velocimeter operatively connected to an active streamer of the predetermined number of streams proximate the first end of that active streamer; and
d) a signal receiver.

2. The system for marine seismic data acquisition of claim 1, wherein the predetermined separation distance is around 12.5 meters.

3. The system for marine seismic data acquisition of claim 1, wherein the acoustic signal source comprises a small volume air gun, a medium volume air gun, and a large volume air gun.

4. The system for marine seismic data acquisition of claim 1, wherein the acoustic signal source comprises an array of acoustic signal sources, the array arranged in a predetermined pattern comprising:
a) a predetermined set of small volume air guns; b) a predetermined set of medium volume air guns; and c) a predetermined set of large volume air guns.

5. The system for marine seismic data acquisition of claim 1, wherein the acoustic signal source comprises a gun string acoustic pinger, a single or multi-level sparker, a boomer, a chirp, or marine vibrator source.

6. The system for marine seismic data acquisition of claim 5, where the gun string acoustic pinger comprises:
a) a deep-penetration, low-frequency acoustic generator suitable for seismic traces with long offsets; andb) a shallow-penetration, high-frequency acoustic generator suitable for seismic traces with seismic traces for near offsets.

7. The system for marine seismic data acquisition of claim 1, wherein the source comprises three gun strings, a middle gun string of the three gun strings comprising a center of the acoustic signal source.

8. The system for marine seismic data acquisition of claim 1, wherein the signal receiver comprises:
a) a vessel; andb) a predetermined set of antennae operatively connected to the vessel.

9. The system for marine seismic data acquisition of claim 1, wherein:
a) the predetermined number of streamers comprises a single active streamer; andb) the length comprises a length sufficient to be distributed over a predetermined two-dimensional area.

10. The system for marine seismic data acquisition of claim 1, wherein:
a) the predetermined number of streamers comprises a plurality of active streamers; andb) the length comprises a length sufficient to be distributed over a three-dimensional volume of the Earth’s subsurface.

11. The system for marine seismic data acquisition of claim 1, wherein the acoustic signal source and the acoustic pod receivers comprise a first predetermined set of closely spaced near-offset seismic receivers and a second predetermined set of more sparsely separated long-offset receivers disposed along a single active streamer of the predetermined number of streamers.

12. The system for marine seismic data acquisition of claim 1, wherein the predetermined set of acoustic pod groups comprises a cable mounted acoustic pod receiver.

13. A method of using a system for marine seismic data acquisition comprising a source, at least one gun string comprising an acoustic signal source; a predetermined number of streamers, each streamer comprising an active streamer comprising a predetermined length, a first end, a second end, and a predetermined set of stream sections disposed in-between the first end and the second end; a headfloat operatively connected to the first end of the active streamer; a first relative global positioning system sensor (RGPS) pod operatively connected to the headfloat; a tailbuoy operatively connected to the second end of the active streamer and comprising a second RGPS pod; a plurality of acoustic pod groups where each acoustic pod group is displaced from each adjacent acoustic pod group by a predetermined separation distance along the length of the active streamer and each acoustic pod group comprises a predetermined set of acoustic pod receivers operative to sense an acoustic signal from the acoustic source; a velocimeter operatively connected to an active streamer of the predetermined number of streams proximate the first end of that active streamer; and a signal receiver; the method comprising
a) deploying the system for marine seismic data acquisition subsea;b) firing a first acoustic signal from a first acoustic signal source at a first predetermined set of intervals for shallow penetration;c) using the signal receiver to acquire a first set of ultra-high resolution data from the plurality of acoustic pod groups;d) concurrently, firing a second acoustic signal from a second acoustic signal source at a second predetermined set of intervals for exploratory hydrocarbon surveys;e) using the signal receiver to acquire a second set of ultra-high resolution data from the plurality of acoustic pod groups;f) recording the data at a predetermined recording sampling rate using a recording system; andg) combining the first set of data and the second set of data into a combined dataset recording.

14. The method of claim 13, wherein:
a) the first acoustic signal source comprises a small volume pneumatic or sparker acoustic signal source; andb) the second acoustic signal source comprises a large volume pneumatic or sparker acoustic signal source.

15. The method of claim 13, wherein:
a) the first predetermined set of intervals for shallow penetration comprises a predetermined set of tight intervals; and
b) the second predetermined set of intervals comprise intervals that are sparser than the first predetermined set of tight intervals.

16. The method of claim 13, further comprising optimizing the predetermined recording sampling rate in a time domain to provide a wave-field that is appropriately sampled by the signal receiver, ensuring that the subsurface reconstruction meets both ultra-high and low-resolution or standard resolution imaging requirements.

17. The method of claim 13, wherein combining the data into a combined dataset recording is executed in a single signal receiver pass.
